(19) United States
(12) Patent Application Publication
(10) Pub. No.: US 2025/0291197 A1
(43) Pub. Date: Sep. 18, 2025

(54) Tunable Lens with Shape Memory Alloy Actuators

(71) Applicant: Apple Inc., Cupertino, CA (US)

(72) Inventor: Daniel J Burbridge, Cambridge (GB)

(21) Appl. No.: 18/980,225

(22) Filed: Dec. 13, 2024

Related U.S. Application Data
(60) Provisional application No. 63/564,334, filed on Mar. 12, 2024.

(51) Int. Cl. G02B 27/01; F03G 7/06

(52) U.S. Cl. CPC G02B 27/0176; F03G 7/06143; G02B 2027/0154; G02B 2027/0161

(57) ABSTRACT

An electronic device may include a lens module with a tunable lens. The tunable lens may include a flexible lens element and a lens shaping structure attached to the flexible lens element. The lens shaping structure may include a plurality of tabs that are each coupled to a respective actuator. The actuator may have a slot that receives the tab of the lens shaping structure and moves the tab up and down along an axis of displacement. The actuator may have an inner gear and an outer gear with a different number of teeth. Positioning equipment may move the outer gear in a circular path to rotate the inner gear. The positioning equipment may include four shape memory actuators with respective parallel SMA wires. Some of the SMA actuators may include flexures to provide a thin form factor for the actuator.

This application claims the benefit of U.S. provisional patent application No. 63/564,334 filed Mar. 12, 2024, which is hereby incorporated by reference herein in its entirety.

### BACKGROUND

This relates generally to electronic devices and, more particularly, to wearable electronic device systems.

Electronic devices are sometimes configured to be worn by users. For example, head-mounted devices are provided with head-mounted structures that allow the devices to be worn on users' heads. The head-mounted devices may include optical systems with lenses.

Head-mounted devices typically include lenses with fixed shapes and properties. If care is not taken, it may be difficult to adjust these types of lenses to optimally present content to each user of the head-mounted device.

### SUMMARY

A tunable lens may include a lens element having a periphery, a ring-shaped chassis with a length that extends around the periphery, and an actuator in the ring-shaped chassis configured to adjust a position of the lens element. The actuator may include a screw, a nut that is aligned with the screw and that is attached to the lens element, an inner gear that is connected to the screw, an outer gear that surrounds the inner gear, and at least four shape memory alloy (SMA) actuators that are configured rotate the inner gear by moving the outer gear. Each one of the four SMA actuators may have a respective SMA wire that extends parallel to the length of the ring-shaped chassis.

A tunable lens may include a lens element having a periphery, a ring-shaped chassis that extends around the periphery, and an actuator in the ring-shaped chassis configured to adjust a position of the lens element. The actuator may include a screw, a nut that is aligned with the screw and that is attached to the lens element, an inner gear that is connected to the screw, an outer gear that surrounds the inner gear, and positioning equipment that is configured to rotate the inner gear by moving the outer gear in a circular path without rotating the outer gear. The inner gear and the outer gear may have a different number of teeth.

An actuator may include a screw, a nut that is aligned with the screw, an inner gear that is connected to the screw, an outer gear that surrounds the inner gear, a first shape memory alloy (SMA) actuator comprising a first SMA wire, a second SMA actuator comprising a second SMA wire, a third SMA actuator comprising a third SMA wire, and a fourth SMA actuator comprising a fourth SMA wire. The first, second, third, and fourth SMA wires may be parallel, the inner gear and the outer gear may have a different number of teeth, rotation of the inner gear may cause rotation of the screw, rotation of the screw may cause displacement of the nut along the screw, and the first, second, third, and fourth SMA actuators may be configured to rotate the inner gear by moving the outer gear in a circular path.

### BRIEF DESCRIPTION OF THE DRAWINGS

FIG. 1 is a schematic diagram of an illustrative electronic device in accordance with some embodiments.

FIG. 2 is a top view of an illustrative head-mounted device with a lens module in accordance with some embodiments.

FIG. 3 is a side view of an illustrative lens module in accordance with some embodiments.

FIGS. 4 and 5 are side views of an illustrative tunable lens in different tuning states in accordance with some embodiments.

FIG. 6 is a top view of an illustrative tunable lens with a lens shaping structure in accordance with some embodiments.

FIG. 7 is a side view of an illustrative actuator with an inner gear and an outer gear having a different number of teeth in accordance with some embodiments.

FIG. 8 is a top view of the illustrative actuator of FIG. 7 in accordance with some embodiments.

FIG. 9 is a top view of an illustrative actuator with an outer gear that is moved in a circular path by four shape memory alloy actuators in accordance with some embodiments.

FIG. 10A is a top view of an illustrative actuator with an outer gear that is moved in a circular path by two shape memory alloy actuators connected to flexures and two shape memory alloy actuators not connected to flexures in accordance with some embodiments.

FIG. 10B is a rear view of the illustrative actuator of FIG. 10A in accordance with some embodiments.

### DETAILED DESCRIPTION

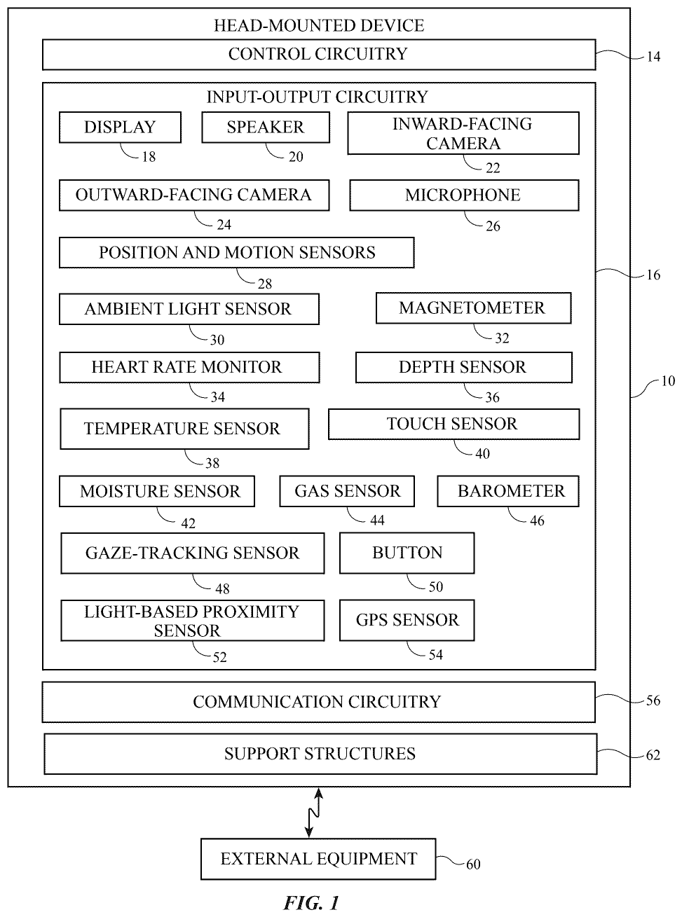

A schematic diagram of an illustrative electronic device is shown in FIG. 1. As shown in FIG. 1, electronic device 10 (sometimes referred to as head-mounted device 10, system 10, head-mounted display 10, etc.) may have control circuitry 14. In addition to being a head-mounted device, electronic device 10 may be other types of electronic devices such as a cellular telephone, laptop computer, speaker, computer monitor, electronic watch, tablet computer, etc. Control circuitry 14 may be configured to perform operations in head-mounted device 10 using hardware (e.g., dedicated hardware or circuitry), firmware and/or software. Software code for performing operations in head-mounted device 10 and other data is stored on non-transitory computer readable storage media (e.g., tangible computer readable storage media) in control circuitry 14. The software code may sometimes be referred to as software, data, program instructions, instructions, or code. The non-transitory computer readable storage media (sometimes referred to generally as memory) may include non-volatile memory such as non-volatile random-access memory (NVRAM), one or more hard drives (e.g., magnetic drives or solid-state drives), one or more removable flash drives or other removable media, or the like. Software stored on the non-transitory computer readable storage media may be executed on the processing circuitry of control circuitry 14. The processing circuitry may include application-specific integrated circuits with processing circuitry, one or more microprocessors, digital signal processors, graphics processing units, a central processing unit (CPU) or other processing circuitry.

Head-mounted device 10 may include input-output circuitry 16. Input-output circuitry 16 may be used to allow a user to provide head-mounted device 10 with user input. Input-output circuitry 16 may also be used to gather information on the environment in which head-mounted device 10 is operating. Output components in circuitry 16 may allow head-mounted device 10 to provide a user with output.

As shown in FIG. 1, input-output circuitry 16 may include a display such as display 18. Display 18 may be used to display images for a user of head-mounted device 10. Display 18 may be a transparent or translucent display so that a user may observe physical objects through the display while computer-generated content is overlaid on top of the physical objects by presenting computer-generated images on the display. A transparent or translucent display may be formed from a transparent or translucent pixel array (e.g., a transparent organic light-emitting diode display panel) or may be formed by a display device that provides images to a user through a transparent structure such as a beam splitter, holographic coupler, or other optical coupler (e.g., a display device such as a liquid crystal on silicon display). Alternatively, display 18 may be an opaque display that blocks light from physical objects when a user operates head-mounted device 10. In this type of arrangement, a pass-through camera may be used to display physical objects to the user. The pass-through camera may capture images of the physical environment and the physical environment images may be displayed on the display for viewing by the user. Additional computer-generated content (e.g., text, game-content, other visual content, etc.) may optionally be overlaid over the physical environment images to provide an extended reality environment for the user. When display 18 is opaque, the display may also optionally display entirely computer-generated content (e.g., without displaying images of the physical environment).

Display 18 may include one or more optical systems (e.g., lenses) (sometimes referred to as optical assemblies) that allow a viewer to view images on display(s) 18. A single display 18 may produce images for both eyes or a pair of displays 18 may be used to display images. In configurations with multiple displays (e.g., left and right eye displays), the focal length and positions of the lenses may be selected so that any gap present between the displays will not be visible to a user (e.g., so that the images of the left and right displays overlap or merge seamlessly). Display modules (sometimes referred to as display assemblies) that generate different images for the left and right eyes of the user may be referred to as stereoscopic displays. The stereoscopic displays may be capable of presenting two-dimensional content (e.g., a user notification with text) and three-dimensional content (e.g., a simulation of a physical object such as a cube).

The example of device 10 including a display is merely illustrative and display(s) 18 may be omitted from device 10 if desired. Device 10 may include an optical pass-through area where real-world content is viewable to the user either directly or through a tunable lens.

Input-output circuitry 16 may include various other input-output devices. For example, input-output circuitry 16 may include one or more speakers 20 that are configured to play audio and one or more microphones 26 that are configured to capture audio data from the user and/or from the physical environment around the user.

Input-output circuitry 16 may also include one or more cameras such as an inward-facing camera 22 (e.g., that face the user's face when the head-mounted device is mounted on the user's head) and an outward-facing camera 24 (that face the physical environment around the user when the head-mounted device is mounted on the user's head). Cameras 22 and 24 may capture visible light images, infrared images, or images of any other desired type. The cameras may be stereo cameras if desired. Inward-facing camera 22 may capture images that are used for gaze-detection operations, in one possible arrangement. Outward-facing camera 24 may capture pass-through video for head-mounted device 10.

As shown in FIG. 1, input-output circuitry 16 may include position and motion sensors 28 (e.g., compasses, gyroscopes, accelerometers, and/or other devices for monitoring the location, orientation, and movement of head-mounted device 10, satellite navigation system circuitry such as Global Positioning System circuitry for monitoring user location, etc.). Using sensors 28, for example, control circuitry 14 can monitor the current direction in which a user's head is oriented relative to the surrounding environment (e.g., a user's head pose). One or more of cameras 22 and 24 may also be considered part of position and motion sensors 28. The cameras may be used for face tracking (e.g., by capturing images of the user's jaw, mouth, etc. while the device is worn on the head of the user), body tracking (e.g., by capturing images of the user's torso, arms, hands, legs, etc. while the device is worn on the head of user), and/or for localization (e.g., using visual odometry, visual inertial odometry, or other simultaneous localization and mapping (SLAM) technique).

Input-output circuitry 16 may also include other sensors and input-output components if desired. As shown in FIG. 1, input-output circuitry 16 may include an ambient light sensor 30. The ambient light sensor may be used to measure ambient light levels around head-mounted device 10. The ambient light sensor may measure light at one or more wavelengths (e.g., different colors of visible light and/or infrared light).

Input-output circuitry 16 may include a magnetometer 32. The magnetometer may be used to measure the strength and/or direction of magnetic fields around head-mounted device 10.

Input-output circuitry 16 may include a heart rate monitor 34. The heart rate monitor may be used to measure the heart rate of a user wearing head-mounted device 10 using any desired techniques.

Input-output circuitry 16 may include a depth sensor 36. The depth sensor may be a pixelated depth sensor (e.g., that is configured to measure multiple depths across the physical environment) or a point sensor (that is configured to measure a single depth in the physical environment). The depth sensor (whether a pixelated depth sensor or a point sensor) may use phase detection (e.g., phase detection autofocus pixel(s)) or light detection and ranging (LIDAR) to measure depth. Any combination of depth sensors may be used to determine the depth of physical objects in the physical environment.

Input-output circuitry 16 may include a temperature sensor 38. The temperature sensor may be used to measure the temperature of a user of head-mounted device 10, the temperature of head-mounted device 10 itself, or an ambient temperature of the physical environment around head-mounted device 10.

Input-output circuitry 16 may include a touch sensor 40. The touch sensor may be, for example, a capacitive touch sensor that is configured to detect touch from a user of the head-mounted device.

Input-output circuitry 16 may include a moisture sensor 42. The moisture sensor may be used to detect the presence of moisture (e.g., water) on, in, or around the head-mounted device.

Input-output circuitry 16 may include a gas sensor 44. The gas sensor may be used to detect the presence of one or more gases (e.g., smoke, carbon monoxide, etc.) in or around the head-mounted device.

Input-output circuitry 16 may include a barometer 46. The barometer may be used to measure atmospheric pressure, which may be used to determine the elevation above sea level of the head-mounted device.

Input-output circuitry 16 may include a gaze-tracking sensor 48 (sometimes referred to as gaze-tracker 48 and gaze-tracking system 48). The gaze-tracking sensor 48 may include a camera and/or other gaze-tracking sensor components (e.g., light sources that emit beams of light so that reflections of the beams from a user's eyes may be detected) to monitor the user's eyes. Gaze-tracker 48 may face a user's eyes and may track a user's gaze. A camera in the gaze-tracking system may determine the location of a user's eyes (e.g., the centers of the user's pupils), may determine the direction in which the user's eyes are oriented (the direction of the user's gaze), may determine the user's pupil size (e.g., so that light modulation and/or other optical parameters and/or the amount of gradualness with which one or more of these parameters is spatially adjusted and/or the area in which one or more of these optical parameters is adjusted is adjusted based on the pupil size), may be used in monitoring the current focus of the lenses in the user's eyes (e.g., whether the user is focusing in the near field or far field, which may be used to assess whether a user is day dreaming or is thinking strategically or tactically), and/or other gaze information. Cameras in the gaze-tracking system may sometimes be referred to as inward-facing cameras, gaze-detection cameras, eye-tracking cameras, gaze-tracking cameras, or eye-monitoring cameras. If desired, other types of image sensors (e.g., infrared and/or visible light-emitting diodes and light detectors, etc.) may also be used in monitoring a user's gaze. The use of a gaze-detection camera in gaze-tracker 48 is merely illustrative.

Input-output circuitry 16 may include a button 50. The button may include a mechanical switch that detects a user press during operation of the head-mounted device.

Input-output circuitry 16 may include a light-based proximity sensor 52. The light-based proximity sensor may include a light source (e.g., an infrared light source) and an image sensor (e.g., an infrared image sensor) configured to detect reflections of the emitted light to determine proximity to nearby objects.

Input-output circuitry 16 may include a global positioning system (GPS) sensor 54. The GPS sensor may determine location information for the head-mounted device. The GPS sensor may include one or more antennas used to receive GPS signals. The GPS sensor may be considered a part of position and motion sensors 28.

Input-output circuitry 16 may include any other desired components (e.g., capacitive proximity sensors, other proximity sensors, strain gauges, pressure sensors, audio components, haptic output devices such as vibration motors, light-emitting diodes, other light sources, etc.).

Head-mounted device 10 may also include communication circuitry 56 to allow the head-mounted device to communicate with external equipment (e.g., a tethered computer, a portable device such as a handheld device or laptop computer, one or more external servers, or other electrical equipment). Communication circuitry 56 may be used for both wired and wireless communication with external equipment.

Communication circuitry 56 may include radio-frequency (RF) transceiver circuitry formed from one or more integrated circuits, power amplifier circuitry, low-noise input amplifiers, passive RF components, one or more antennas, transmission lines, and other circuitry for handling RF wireless signals. Wireless signals can also be sent using light (e.g., using infrared communications).

The radio-frequency transceiver circuitry in wireless communications circuitry 56 may handle wireless local area network (WLAN) communications bands such as the 2.4 GHz and 5 GHz Wi-Fi® (IEEE 802.11) bands, wireless personal area network (WPAN) communications bands such as the 2.4 GHz Bluetooth® communications band, cellular telephone communications bands such as a cellular low band (LB) (e.g., 600 to 960 MHz), a cellular low-midband (LMB) (e.g., 1400 to 1550 MHz), a cellular midband (MB) (e.g., from 1700 to 2200 MHz), a cellular high band (HB) (e.g., from 2300 to 2700 MHz), a cellular ultra-high band (UHB) (e.g., from 3300 to 5000 MHz, or other cellular communications bands between about 600 MHz and about 5000 MHz (e.g., 3G bands, 4G LTE bands, 5G New Radio Frequency Range 1 (FR1) bands below 10 GHz, etc.), a near-field communications (NFC) band (e.g., at 13.56 MHz), satellite navigations bands (e.g., an L1 global positioning system (GPS) band at 1575 MHz, an L5 GPS band at 1176 MHz, a Global Navigation Satellite System (GLONASS) band, a BeiDou Navigation Satellite System (BDS) band, etc.), ultra-wideband (UWB) communications band(s) supported by the IEEE 802.15.4 protocol and/or other UWB communications protocols (e.g., a first UWB communications band at 6.5 GHz and/or a second UWB communications band at 8.0 GHz), and/or any other desired communications bands.

The radio-frequency transceiver circuitry may include millimeter/centimeter wave transceiver circuitry that supports communications at frequencies between about 10 GHz and 300 GHz. For example, the millimeter/centimeter wave transceiver circuitry may support communications in Extremely High Frequency (EHF) or millimeter wave communications bands between about 30 GHz and 300 GHz and/or in centimeter wave communications bands between about 10 GHz and 30 GHz (sometimes referred to as Super High Frequency (SHF) bands). As examples, the millimeter/centimeter wave transceiver circuitry may support communications in an IEEE K communications band between about 18 GHz and 27 GHz, a Kₐ communications band between about 26.5 GHz and 40 GHz, a Kᵤ communications band between about 12 GHz and 18 GHz, a V communications band between about 40 GHz and 75 GHz, a W communications band between about 75 GHz and 110 GHz, or any other desired frequency band between approximately 10 GHz and 300 GHz. If desired, the millimeter/centimeter wave transceiver circuitry may support IEEE 802.11ad communications at 60 GHz (e.g., WiGig or 60 GHz Wi-Fi bands around 57-61 GHz), and/or 5^{th} generation mobile networks or 5^{th} generation wireless systems (5G) New Radio (NR) Frequency Range 2 (FR2) communications bands between about 24 GHz and 90 GHz.

Antennas in wireless communications circuitry 56 may include antennas with resonating elements that are formed from loop antenna structures, patch antenna structures, inverted-F antenna structures, slot antenna structures, planar inverted-F antenna structures, helical antenna structures, dipole antenna structures, monopole antenna structures, hybrids of these designs, etc. Different types of antennas may be used for different bands and combinations of bands. For example, one type of antenna may be used in forming a local wireless link and another type of antenna may be used in forming a remote wireless link antenna.

During operation, head-mounted device 10 may use communication circuitry 56 to communicate with external equipment 60. External equipment 60 may include one or more external servers, an electronic device that is paired with head-mounted device 10 (such as a cellular telephone, a laptop computer, a speaker, a computer monitor, an electronic watch, a tablet computer, earbuds, etc.), a vehicle, an internet of things (IoT) device (e.g., remote control, light switch, doorbell, lock, smoke alarm, light, thermostat, oven, refrigerator, stove, grill, coffee maker, toaster, microwave, etc.), etc.

Electronic device 10 may have housing structures (e.g., housing walls, straps, etc.), as shown by illustrative support structures 62 of FIG. 1. In configurations in which electronic device 10 is a head-mounted device (e.g., a pair of glasses, goggles, a helmet, a hat, etc.), support structures 62 may include head-mounted support structures (e.g., a helmet housing, head straps, temples in a pair of eyeglasses, goggle housing structures, and/or other head-mounted structures). The head-mounted support structures may be configured to be worn on a head of a user during operation of device 10 and may support control circuitry 14, input-output circuitry 16, and/or communication circuitry 56.

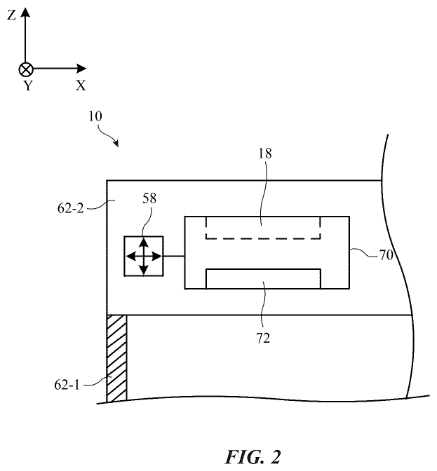

FIG. 2 is a top view of electronic device 10 in an illustrative configuration in which electronic device 10 is a head-mounted device. As shown in FIG. 2, electronic device 10 may include support structures (see, e.g., support structures 62 of FIG. 1) that are used in housing the components of device 10 and mounting device 10 onto a user's head. These support structures may include, for example, structures that form housing walls and other structures for main unit 62-2 (e.g., exterior housing walls, lens module structures, etc.) and eyeglass temples or other supplemental support structures such as structures 62-1 that help to hold main unit 62-2 on a user's face.

The electronic device may include optical modules such as optical module 70. The electronic device may include left and right optical modules that correspond respectively to a user's left eye and right eye. An optical module corresponding to the user's left eye is shown in FIG. 2.

Each optical module 70 includes a corresponding lens module 72 (sometimes referred to as lens stack-up 72, lens 72, or adjustable lens 72). Lens 72 may include one or more lens elements arranged along a common axis. Each lens element may have any desired shape and may be formed from any desired material (e.g., with any desired refractive index). The lens elements may have unique shapes and refractive indices that, in combination, focus light (e.g., from a display or from the physical environment) in a desired manner. Each lens element of lens module 72 may be formed from any desired material (e.g., glass, a polymer material such as polycarbonate or acrylic, a crystal such as sapphire, etc.).

Modules 70 may optionally be individually positioned relative to the user's eyes and relative to some of the housing wall structures of main unit 26-2 using positioning circuitry such as positioner 58. Positioner 58 may include stepper motors, piezoelectric actuators, motors, linear electromagnetic actuators, shape memory alloys (SMAs), and/or other electronic components for adjusting the position of displays, the optical modules 70, and/or lens modules 72. Positioners 58 may be controlled by control circuitry 14 during operation of device 10. For example, positioners 58 may be used to adjust the spacing between modules 70 (and therefore the lens-to-lens spacing between the left and right lenses of modules 70) to match the interpupillary distance IPD of a user's eyes. In another example, the lens module may include an adjustable lens element. The curvature of the adjustable lens element may be adjusted in real time by positioner(s) 58 to compensate for a user's eyesight and/or viewing conditions.

Each optical module may optionally include a display such as display 18 in FIG. 2. As previously mentioned, the displays may be omitted from device 10 if desired. In this type of arrangement, the device may still include one or more lens modules 72 (e.g., through which the user views the real world). In this type of arrangement, real-world content may be selectively focused for a user.

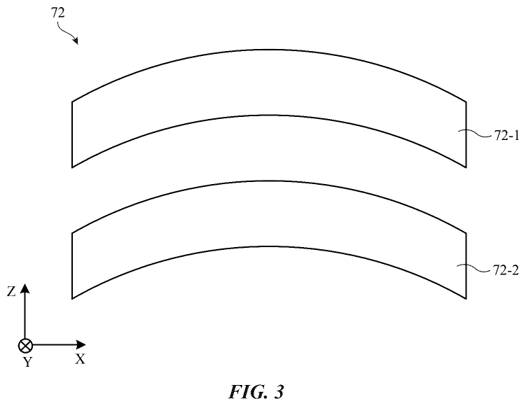

FIG. 3 is a cross-sectional side view of an illustrative lens module with multiple lens elements. As shown, lens module 72 includes a first lens element 72-1 and a second lens element 72-2. Each surface of the lens elements may have any desired curvature. For example, each surface may be a convex surface (e.g., a spherically convex surface, a cylindrically convex surface, or an aspherically convex surface), a concave surface (e.g., a spherically concave surface, a cylindrically concave surface, or an aspherically concave surface), a combination of convex and concave surfaces, or a freeform surface. A spherically curved surface (e.g., a spherically convex or spherically concave surface) may have a constant radius of curvature across the surface. In contrast, an aspherically curved surface (e.g., an aspheric concave surface or an aspheric convex surface) may have a varying radius of curvature across the surface. A cylindrical surface may only be curved about one axis instead of about multiple axes as with the spherical surface. In some cases, one of the lens surfaces may have an aspheric surface that changes from being convex (e.g., at the center) to concave (e.g., at the edges) at different positions on the surface. This type of surface may be referred to as an aspheric surface, a primarily convex (e.g., the majority of the surface is convex and/or the surface is convex at its center) aspheric surface, a freeform surface, and/or a primarily convex (e.g., the majority of the surface is convex and/or the surface is convex at its center) freeform surface. A freeform surface may include both convex and concave portions and/or curvatures defined by polynomial series and expansions. Alternatively, a freeform surface may have varying convex curvatures or varying concave curvatures (e.g., different portions with different radii of curvature, portions with curvature in one direction and different portions with curvature in two directions, etc.). Herein, a freeform surface that is primarily convex (e.g., the majority of the surface is convex and/or the surface is convex at its center) may sometimes still be referred to as a convex surface and a freeform surface that is primarily concave (e.g., the majority of the surface is concave and/or the surface is concave at its center) may sometimes still be referred to as a concave surface. In one example, shown in FIG. 3, lens element 72-1 has a convex surface that faces display 18 and an opposing concave surface. Lens element 72-2 has a convex surface that faces lens element 72-1 and an opposing concave surface.

One or both of lens elements 72-1 and 72-2 may be adjustable. In one example, lens element 72-1 is a non-adjustable lens element whereas lens element 72-2 is an adjustable lens element. The adjustable lens element 72-2 may be used to accommodate a user's eyeglass prescription, for example. The shape of lens element 72-2 may be adjusted if a user's eyeglass prescription changes (without needing to replace any of the other components within device 10). As another possible use case, a first user with a first eyeglass prescription (or no eyeglass prescription) may use device 10 with lens clement 72-2 having a first shape and a second, different user with a second eyeglass prescription may use device 10 with lens element 72-2 having a second shape that is different than the first shape. Lens element 72-2 may have varying lens power and/or may provide varying amounts and orientations of astigmatism correction to provide prescription correction for the user.

The example of lens module 72 including two lens elements is merely illustrative. In general, lens module 72 may include any desired number of lens elements (e.g., one, two, three, four, more than four, etc.). Any subset or all of the lens elements may optionally be adjustable. Any of the adjustable lens elements in the lens module may optionally be fluid-filled adjustable lenses. Lens module 72 may also include any desired additional optical layers (e.g., partially reflective mirrors that reflect 50% of incident light, linear polarizers, retarders such as quarter wave plates, reflective polarizers, circular polarizers, reflective circular polarizers, etc.) to manipulate light that passes through lens module.

In one possible arrangement, lens element 72-1 may be a removable lens element. In other words, a user may be able to easily remove and replace lens element 72-1 within optical module 70. This may allow lens element 72-1 to be customizable. If lens element 72-1 is permanently affixed to the lens assembly, the lens power provided by lens element 72-1 cannot be easily changed. However, by making lens element 72-1 customizable, a user may select a lens element 72-1 that best suits their eyes and place the appropriate lens element 72-1 in the lens assembly. The lens element 72-1 may be used to accommodate a user's eyeglass prescription, for example. A user may replace lens element 72-1 with an updated lens element if their eyeglass prescription changes (without needing to replace any of the other components within electronic device 10). Lens element 72-1 may have varying lens power and/or may provide varying amount of astigmatism correction to provide prescription correction for the user. Lens element 72-1 may include one or more attachment structures that are configured to attach to corresponding attachment structures included in optical module 70, lens element 72-2, support structures 26, or another structure in electronic device 10.

In contrast with lens element 72-1, lens element 72-2 may not be a removable lens element. Lens element 72-2 may therefore sometimes be referred to as a permanent lens element, non-removable lens element, etc. The example of lens element 72-2 being a non-removable lens element is merely illustrative. In another possible arrangement, lens element 72-2 may also be a removable lens element (similar to lens element 72-1).

As previously mentioned, one or more of the adjustable lens elements may be a fluid-filled lens element. An example is described herein where lens element 72-2 from FIG. 3 is a fluid-filled lens element. When lens element 72-2 is a fluid-filled lens element, the lens element may include one or more components that define the surfaces of lens clement 72-2. These elements may also be referred to as lens elements. In other words, adjustable lens element 72-2 (sometimes referred to as adjustable lens module 72-2, adjustable lens 72-2, tunable lens 72-2, etc.) may be formed by multiple respective lens elements.

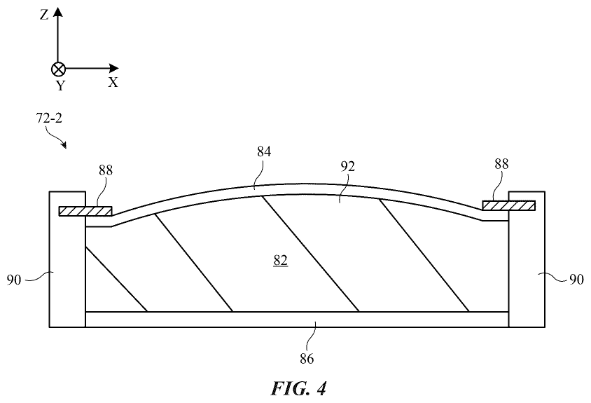

FIG. 4 is a cross-sectional side view of adjustable fluid-filled lens element 72-2. As shown, fluid-filled chamber 82 (sometimes referred to as chamber 82, fluid chamber 82, primary chamber 82, etc.) that includes fluid 92 is interposed between lens elements 84 and 86. Lens elements 84 and 86 may sometimes be referred to as part of chamber 82 or may sometimes be referred to as separate from chamber 82. Fluid 92 may be a liquid, gel, or gas with a pre-determined index of refraction (and may therefore sometimes be referred to as liquid 92, gel 92, or gas 92). The fluid may sometimes be referred to as an index-matching oil, an optical oil, an optical fluid, an index-matching material, an index-matching liquid, etc. Lens elements 84 and 86 may have the same index of refraction or may have different indices of refraction. Fluid 92 that fills chamber 82 between lens elements 84 and 86 may have an index of refraction that is the same as the index of refraction of lens element 84 but different from the index of refraction of lens element 86, may have an index of refraction that is the same as the index of refraction of lens element 86 but different from the index of refraction of lens element 84, may have an index of refraction that is the same as the index of refraction of lens element 84 and lens element 86, or may have an index of refraction that is different from the index of refraction of lens element 84 and lens element 86. Lens elements 84 and 86 may have a circular footprint, may have an elliptical footprint, may have or may have a footprint any another desired shape (e.g., an irregular footprint).

The amount of fluid 92 in chamber 82 may have a constant volume or an adjustable volume. If the amount of fluid is adjustable, the lens module may also include a fluid reservoir and a fluid controlling component (e.g., a pump, stepper motor, piezoelectric actuator, shape memory alloy (SMA), motor, linear electromagnetic actuator, and/or other electronic component that applies a force to the fluid in the fluid reservoir) for selectively transferring fluid between the fluid reservoir and the chamber.

Lens elements 84 and 86 may be transparent lens elements formed from any desired material (e.g., glass, a polymer material such as polycarbonate or acrylic, a crystal such as sapphire, etc.). Each one of lens elements 84 and 86 may be elastomeric, semi-rigid, or rigid. In one example, lens element 84 is an elastomeric lens element whereas lens element 86 is a rigid lens element.

Elastomeric lens elements (e.g., lens element 84 in FIGS. 4 and 5) may be formed from a natural or synthetic polymer that has a low Young's modulus for high flexibility. For example the elastomeric membrane may be formed from a material having a Young's modulus of less than 1 GPa, less than 0.5 GPa, less than 0.1 GPa, etc.

Semi-rigid lens elements may be formed from a semi-rigid material that is stiff and solid, but not inflexible. A semi-rigid lens element may, for example, be formed from a thin layer of polymer or glass. Semi-rigid lens elements may be formed from a material having a Young's modulus that is greater than 1 Gpa, greater than 2 GPa, greater than 3 GPa, greater than 10 GPa, greater than 25 GPa, etc. Semi-rigid lens elements may be formed from polycarbonate, polyethylene terephthalate (PET), polymethylmethacrylate (PMMA), acrylic, glass, or any other desired material. The properties of semi-rigid lens elements may result in the lens element becoming rigid along a first axis when the lens element is curved along a second axis perpendicular to the first axis or, more generally, for the product of the curvature along its two principal axes of curvature to remain roughly constant as it flexes. This is in contrast to an elastomeric lens element, which remains flexible along a first axis even when the lens element is curved along a second axis perpendicular to the first axis. The properties of semi-rigid lens elements may allow the semi-rigid lens elements to form a cylindrical lens with tunable lens power and a tunable axis.

Rigid lens elements (e.g., lens element 86 in FIGS. 4 and 5) may be formed from glass, a polymer material such as polycarbonate or acrylic, a crystal such as sapphire, etc. In general, the rigid lens elements may not deform when pressure is applied to the lens elements within the lens module. In other words, the shape and position of the rigid lens elements may be fixed. Each surface of a rigid lens element may be planar, concave (e.g., spherically, aspherically, or cylindrically concave), or convex (e.g., spherically, aspherically, or cylindrically convex). Rigid lens elements may be formed from a material having a Young's modulus that is greater than greater than 25 GPa, greater than 30 GPa, greater than 40 GPa, greater than 50 GPa, etc.

In addition to lens elements 84 and 86 and fluid-filled chamber 82, lens module 72-2 also includes a lens shaping element 88. Lens shaping element 88 may be coupled to one or more actuators 90 (e.g., positioned around the circumference of the lens module). The lens shaping clement 88 may also be coupled to lens element 84. Actuators 90 may be adjusted to position lens shaping element 88 (sometimes referred to as lens shaper 88, deformable lens shaper 88, lens shaping structure 88, lens shaping member 88, annular member 88, ring-shaped structure 88, etc.). The lens shaping element 88 in turn manipulates the positioning/shape of lens element 84. In this way, the curvature of the lens element 84 (and accordingly, the lens power of lens module 72-2) may be adjusted. An example of actuators 90 and lens shaper 88 being used to change the curvature of lens element 84 in FIG. 5. As shown, lens shaper 88 is moved in direction 94 by actuators 90. This results in lens element 84 having more curvature in FIG. 5 than in FIG. 4.

The example of tunable lens element 72-2 being a fluid-filled lens element is merely illustrative. In general, tunable lens element 72-2 may be any desired type of tunable lens element with adjustable optical power.

The shape (and corresponding optical power) of tunable lens element 72-2 may be adjusted in response to information from any of the components in input-output circuitry 16.

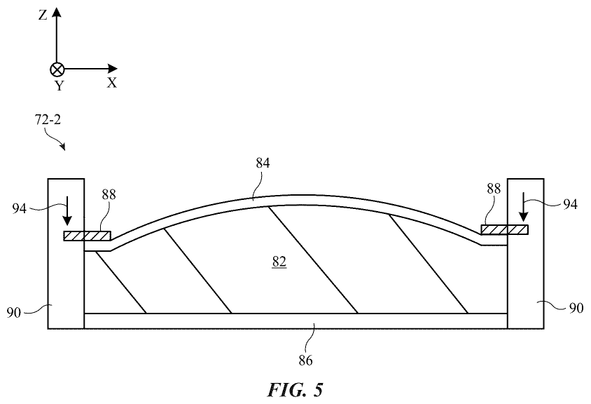

FIG. 6 is a top view of an illustrative lens shaping element 88. As shown, lens shaping element 88 may have an annular or ring shape with the lens shaping element surrounding a central opening. The lens shaping element may have any desired shape. For example, the lens shaping clement may be circular, elliptical, or have an irregular shape. In the example of FIG. 6, the lens shaping element has an elliptical shape (e.g., a non-uniform radius around the ring shape). For example, a first distance 96 (e.g., a minimum distance) from the center of the central opening to the edge of the lens shaping element may be smaller than a second distance 98 (e.g., a maximum distance) from the center of the central opening to the edge of the lens shaping clement. Distance 96 and 98 may be less than 100 millimeters, less than 60 millimeters, less than 40 millimeters, less than 30 millimeters, greater than 10 millimeters, greater than 20 millimeters, between 10 and 50 millimeters, etc.

Lens shaping element 88 has a plurality of tabs 88E that extend from the main portion of the lens shaping element. The tabs 88E (sometimes referred to as extensions 88E, actuator points 88E, etc.) may each be coupled to a respective actuator 90. Each actuator may selectively move its respective extension 88E up and down (e.g., in the Z-direction) to control the position of tab 88E in the Z-direction. In other words, actuator 90 is a linear actuator.

FIG. 6 shows how a plurality of tabs 88E (and corresponding actuators) may be distributed around the perimeter of lens shaping element 88. Tabs 88E may be distributed around lens shaping element 88 in a uniform manner (e.g., with equal spacing between each pair of adjacent tabs 88E) or in a non-uniform manner (e.g., with unequal spacing between at least two of the adjacent tabs 88E).

Between each pair of adjacent tabs 88E, there is a lens shaper segment 88S. In the example of FIG. 6, there are 8 tabs 88E and 8 actuators 90 around the perimeter of lens shaping element 88. This example is merely illustrative. In general, more tabs (and corresponding actuators) allows for greater control of the shape of the lens element (e.g., lens element 84) to which lens shaping element 88 is coupled. Any desired number of tabs and actuators (e.g., one, two, three, four, more than four, more than six, more than eight, more than ten, more than twelve, more than twenty, less than twenty, less than ten, between four and twelve, etc.) may be used depending upon the specific target shapes for the lens element, the target cost/complexity of the lens module, etc.

Lens shaping element 88 may be elastomeric (e.g., a natural or synthetic polymer that has a low Young's modulus for high flexibility, as discussed above in greater detail) or semi-rigid (e.g., formed from a semi-rigid material that is stiff and solid, but not inflexible, as discussed above in greater detail). A semi-rigid lens shaping element may, for example, be formed from a thin layer of polymer, glass, metal, etc. Because lens shaping element 88 is formed in a ring around the lens module, lens shaping element 88 does not need to be transparent (and therefore may be formed from an opaque material such as metal). The rigidity of lens shaping element 88 may be selected such that the lens shaping element assumes desired target shapes when manipulated by the actuators around its perimeter.

One or more structures such as a lens housing 102 (sometimes referred to as housing 102, lens chassis 102, chassis 102, support structure 102, bezel 102, ring-shaped housing 102, ring-shaped chassis 102, etc.) may also be included in tunable lens element 72-2. Actuators 90 may be positioned within lens housing 102. Lens housing 102 may optionally define a portion of the fluid-filled chamber 82. Lens housing 102 may extend in a ring around the periphery of the tunable lens.

Lens housing 102 may have a width 104. Each actuator 90 may have a width 106. In some devices, it may be desirable for the magnitude of width 104 to be small (e.g., to achieve a thin bezel with a target aesthetic appearance). However, the magnitude of width 104 need to be greater than or equal to the magnitude of width 106 (of actuators 90) to accommodate actuators 90. In other words, the width of the actuators may be a limiting factor in the width of the lens housing.

To mitigate the width 106 of actuator 90, the actuator may include an inner gear and an outer gear with different number of teeth. The outer gear may be moved in a circular motion (without rotating the outer gear) to cause rotation of the inner gear. Positioning equipment may be included in the actuator to move the outer gear in a circular motion.

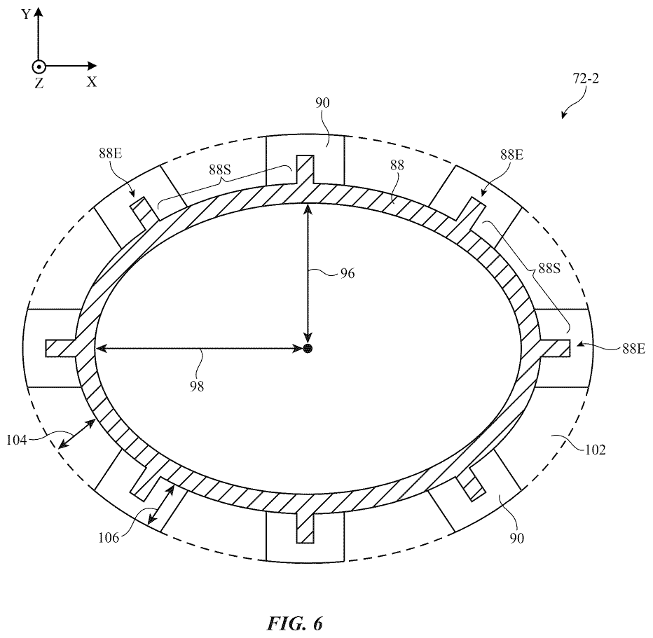

FIG. 7 is a side view of an illustrative actuator 90 with an inner gear and an outer gear having different number of teeth. As shown in FIG. 7, actuator 90 includes an inner gear 112 and an outer gear 114. Outer gear 114 may completely laterally surround inner gear 112. Inner gear 112 is connected to screw 164. In other words, rotation of gear 112 causes screw 164 to rotate. A nut 168 may be attached between screw 164 and guide rod 166. Guide rod 166 is a straight vertical pole that is inserted through an opening in nut 168. The guide rod may prevent nut 168 from spinning when screw 164 is spun by gear 112. Nut 168 may have threads that mate with the threads of screw 164. Because the nut cannot spin (due to the guide rod), the nut will travel up and down along direction 174 (e.g., parallel to the Z-axis) when screw 164 is rotated.

Nut 168 may further include an opening 170 (sometimes referred to as recess 170, slot 170, etc.) that receives a respective extension 88E of lens shaping element 88. Opening 170 may be defined at least partially by nut 168 or another component that is fixed to nut 168. The extension 88E is therefore moved up and down along direction 174 in unison with nut 168 in response to rotation of screw 164. In other words, the position of slot 170 relative to nut 168 is fixed. Rotation of screw 164 in a first direction (e.g., clockwise) may cause nut 168 and extension 88E to be moved in a second direction (e.g., the positive Z-direction) whereas rotation of screw 164 in a third direction (e.g., counter-clockwise) that is opposite the first direction may cause nut 168 and extension 88E to be moved in a fourth direction (e.g., the negative Z-direction) that is opposite the third direction.

To rotate inner gear 112 (and, correspondingly, screw 164), positioning equipment 116 may move outer gear 114 in a circular path (without rotating the outer gear). Moving outer gear 114 in a circular path may rotate inner gear 112, which rotates screw 164, which moves nut 168 up and down along direction 174.

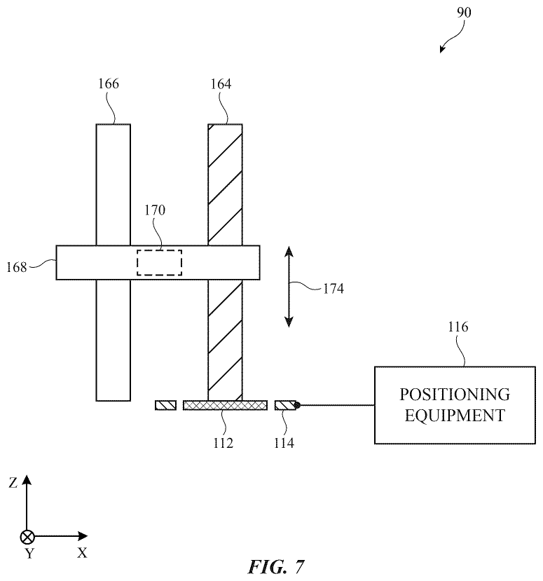

FIG. 8 is a top view of actuator 90 showing how inner gear 112 and outer gear 114 may have different numbers of teeth. FIG. 8 also shows the footprint of screw 164 (which overlaps and is attached to inner screw 112). In the example of FIG. 8, inner gear 112 has 30 teeth 112T and outer gear 114 has 31 teeth 114T. Outer gear 114 may be controlled by positioning equipment 116 to move in a circular path 118. Outer gear 114 may be moved in a complete circle while maintaining a constant angular position within the XY-plane. In other words, the outer gear does not rotate while being moved along the complete circular path. The outer gear may be moved in a circular path in a clockwise direction or a counterclockwise direction.

The ratio of the number of complete circular paths by outer gear 114 to the number of complete rotations of inner gear 112 may be equal to the number of teeth on inner gear 112 divided by the difference in the number of teeth between inner gear 112 and outer gear 114. In the example of FIG. 8, inner gear 112 has 30 teeth, outer gear 114 has 31 teeth, and the difference in the number of teeth between inner gear 112 and outer gear 114 is therefore equal to 1. The ratio of the number of complete circular paths by outer gear 114 to the number of complete rotations of inner gear 112 is therefore equal to 30:1 in FIG. 8. In an example where outer gear has 32 teeth, the ratio of the number of complete circular paths by outer gear 114 to the number of complete rotations of inner gear 112 is equal to 30:2 (15:1).

FIG. 8 shows how positioning equipment 116 may include multiple positioners that are configured to move outer gear 114 in a complete circular path. As shown, a first positioner 116-1 may be attached to outer gear 114 at a given point and may selectively apply a force to the given point in direction 120-1 (e.g., in the positive X-direction). A second positioner 116-2 may be attached to outer gear 114 at a given point and may selectively apply a force to the given point in direction 120-2 (e.g., in the negative Y-direction). Positioners 116-1 and 116-2 in FIG. 8 are attached to the same point.

A third positioner 116-3 may be attached to outer gear 114 at a given point and may selectively apply a force to the given point in direction 120-3 (e.g., in the positive Y-direction). A second positioner 116-4 may be attached to outer gear 114 at a given point and may selectively apply a force to the given point in direction 120-4 (e.g., in the negative X-direction). Positioners 116-3 and 116-4 in FIG. 8 are attached to the same point.

Positioners 116-1, 116-2, 116-3, and 116-4 may be controlled (e.g., by control circuitry 14) to move outer gear 114 within the XY-plane in a circular path without rotating the outer gear.

Positioners 116-1, 116-2, 116-3, and 116-4 may include shape memory alloy (SMA) actuators, piezoelectric actuators, electrostatic actuators, or any other desired type of actuator or other component that generates a linear force. Some actuators (e.g., piezoelectric actuators) may be capable of generating a linear force in two directions. In these instances, only two positioners may be included to manipulate the position of outer gear 114 instead of four positioners as shown in FIG. 8 (e.g., a first positioner is configured to move outer gear 114 in both the positive X-direction and the negative X-direction and a second positioner is configured to move outer gear 114 in both the positive Y-direction and the negative Y-direction). More than four positioners may also be included to manipulate the position of outer gear 114 if desired.

The positions of the connection points of the positioners shown in FIG. 8 are merely illustrative. In general, each positioner may be connected to outer gear 114 at any desired connection point. Outer gear 114 may have opposing upper and lower surfaces connected by side surfaces and there may be connection points on one or more of the side, upper, and lower surfaces. As an example, first and second positioners may be connected to the upper surface of outer gear 114 whereas third and fourth positioners may be connected to the lower surface of outer gear 114.

In the example of FIG. 8, the force vectors applied by the positioners are orthogonal. In other words, direction 120-1 is orthogonal to directions 120-2 and 120-3, direction 120-2 is orthogonal to directions 120-1 and 120-4, etc. This example is merely illustrative. If desired, some of the force vectors may be at non-orthogonal, non-parallel angles relative to one another. As a specific example, the angle between direction 120-1 (e.g., the direction of force applied by positioner 116-1) and direction 120-2 (e.g., the direction of force applied by positioner 116-2) may be less than 90 degrees, less than 85 degrees, less than 80 degrees, less than 70 degrees, less than 60 degrees, less than 45 degrees, etc. The angles of directions 120-1, 120-2, 120-3, and 120-4 may provide additional degrees of freedom through which the actuator performance and form factor may be optimized.

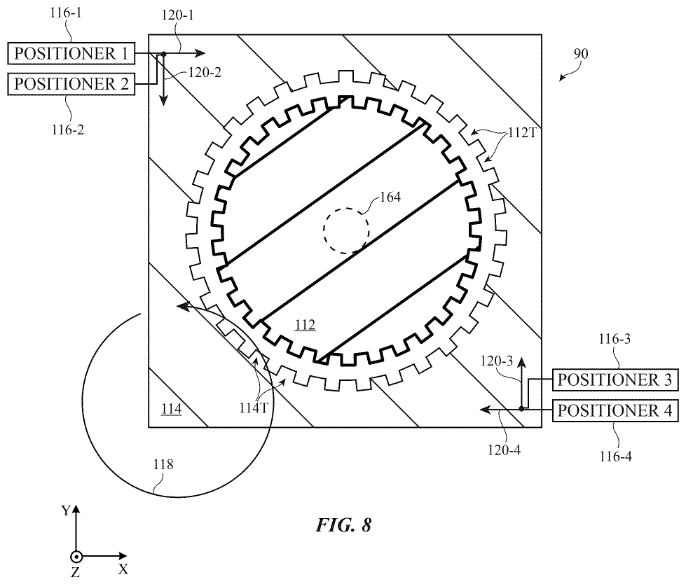

FIG. 9 shows an example where positioners 116-1, 116-2, 116-3, and 116-4 are SMA actuators. SMA actuator 116-1 includes an SMA wire 122-1 that is connected between anchor structures 124-1 and 124-2. Anchor structures 124-1 and 124-2 (sometimes referred to as connector structures 124-1 and 124-2, mechanical connection structures 124-1 and 124-2, electrical connection structures 124-1 and 124-2, mechanical and electrical connection structures 124-1 and 124-2, etc.) may be both mechanically and electrically connected to SMA wire 122-1. Mechanically, anchor structure 124-1 may be attached to a fixed structure in tunable lens 72-2 such as lens housing 102 whereas anchor structure 124-2 may be attached to outer gear 114. Anchor structures 124-1 and 124-2 may also provide electrical connections to SMA wire 122-1. Control circuitry 14 may control voltages applied to anchor structures 124-1 and 124-2 to control a current through SMA wire 122-1. The current through SMA wire 122-1 may be adjusted to selectively contract SMA wire 122-1. When a current is applied to SMA wire 122-1 to cause the SMA wire to contract, the contraction may apply a force to anchor structure 124-2 (and therefore outer gear 114) in the positive X-direction.

SMA actuator 116-2 includes an SMA wire 122-2 that is connected between anchor structures 124-3 and 124-4. Anchor structures 124-3 and 124-4 (sometimes referred to as connector structures 124-3 and 124-4, mechanical connection structures 124-3 and 124-4, electrical connection structures 124-3 and 124-4, mechanical and electrical connection structures 124-3 and 124-4, etc.) may be both mechanically and electrically connected to SMA wire 122-2. Mechanically, anchor structure 124-4 may be attached to a fixed structure in tunable lens 72-2 such as lens housing 102 whereas anchor structure 124-3 may be attached to outer gear 114. Anchor structures 124-3 and 124-4 may also provide electrical connections to SMA wire 122-2. Control circuitry 14 may control voltages applied to anchor structures 124-3 and 124-4 to control a current through SMA wire 122-2. The current through SMA wire 122-2 may be adjusted to selectively contract SMA wire 122-2. When a current is applied to SMA wire 122-2 to cause the SMA wire to contract, the contraction may apply a force to anchor structure 124-3 (and therefore outer gear 114) in the negative Y-direction.

SMA actuator 116-3 includes an SMA wire 122-3 that is connected between anchor structures 124-5 and 124-6. Anchor structures 124-5 and 124-6 (sometimes referred to as connector structures 124-5 and 124-6, mechanical connection structures 124-5 and 124-6, electrical connection structures 124-5 and 124-6, mechanical and electrical connection structures 124-5 and 124-6, etc.) may be both mechanically and electrically connected to SMA wire 122-3. Mechanically, anchor structure 124-6 may be attached to a fixed structure in tunable lens 72-2 such as lens housing 102 whereas anchor structure 124-5 may be attached to outer gear 114. Anchor structures 124-5 and 124-6 may also provide electrical connections to SMA wire 122-3. Control circuitry 14 may control voltages applied to anchor structures 124-5 and 124-6 to control a current through SMA wire 122-3. The current through SMA wire 122-3 may be adjusted to selectively contract SMA wire 122-3. When a current is applied to SMA wire 122-3 to cause the SMA wire to contract, the contraction may apply a force to anchor structure 124-5 (and therefore outer gear 114) in the positive Y-direction.

SMA actuator 116-4 includes an SMA wire 122-4 that is connected between anchor structures 124-7 and 124-8. Anchor structures 124-7 and 124-8 (sometimes referred to as connector structures 124-7 and 124-8, mechanical connection structures 124-7 and 124-8, electrical connection structures 124-7 and 124-8, mechanical and electrical connection structures 124-7 and 124-8, etc.) may be both mechanically and electrically connected to SMA wire 122-4. Mechanically, anchor structure 124-8 may be attached to a fixed structure in tunable lens 72-2 such as lens housing 102 whereas anchor structure 124-7 may be attached to outer gear 114. Anchor structures 124-7 and 124-8 may also provide electrical connections to SMA wire 122-4. Control circuitry 14 may control voltages applied to anchor structures 124-7 and 124-8 to control a current through SMA wire 122-4. The current through SMA wire 122-4 may be adjusted to selectively contract SMA wire 122-4. When a current is applied to SMA wire 122-4 to cause the SMA wire to contract, the contraction may apply a force to anchor structure 124-7 (and therefore outer gear 114) in the negative X-direction.

FIG. 9 therefore illustrates how four SMA actuators may be attached to outer gear 114 and used to move outer gear 114 in a circular path for the purposes of rotating inner gear 112 and corresponding screw 164.

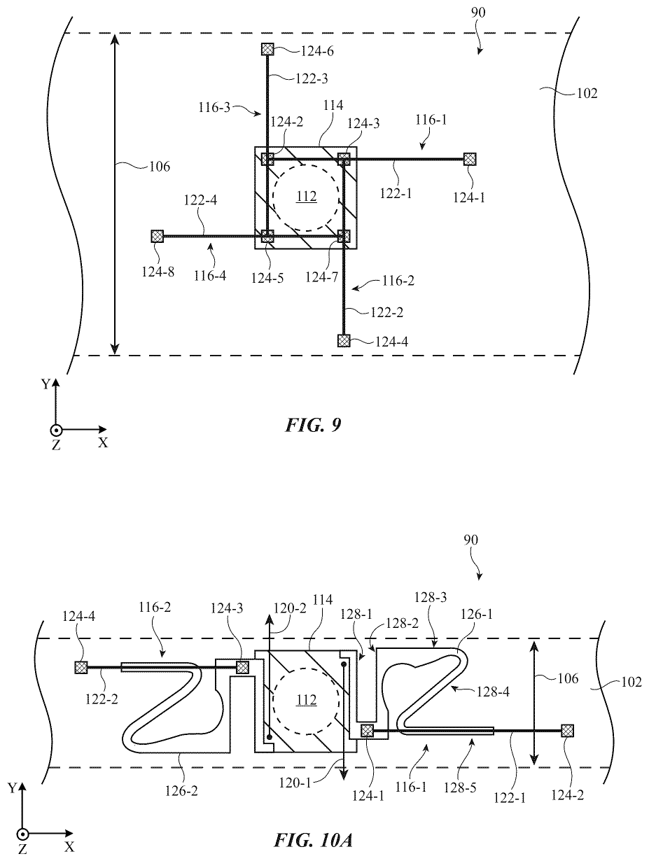

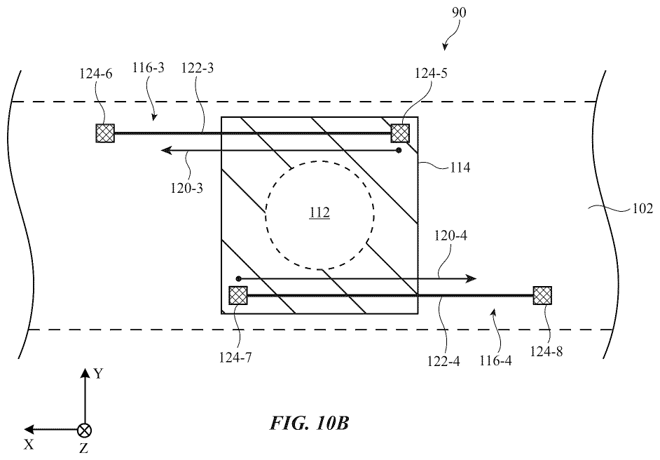

As previously discussed, the width of lens housing 102 may be limited by the width of actuator 90. In FIG. 9, actuator 90 has a width 106. To reduce the width of the actuator (and therefore the width of lens housing 102), actuator 90 may include one or more flexures to redirect the force applied by one or more of the SMA actuators. FIGS. 10A and 10B show an actuator with four SMA actuators, two of which include a corresponding flexure.

FIG. 10A is a top view of actuator 90. SMA actuator 116-1 in FIG. 10A includes an SMA wire 122-1 that is connected between anchor structures 124-1 and 124-2. Anchor structures 124-1 and 124-2 (sometimes referred to as connector structures 124-1 and 124-2, mechanical connection structures 124-1 and 124-2, electrical connection structures 124-1 and 124-2, mechanical and electrical connection structures 124-1 and 124-2, etc.) may be both mechanically and electrically connected to SMA wire 122-1. Mechanically, anchor structure 124-2 may be attached to a fixed structure in tunable lens 72-2 such as lens housing 102 whereas anchor structure 124-1 may be attached to flexure 126-1. Anchor structures 124-1 and 124-2 may also provide electrical connections to SMA wire 122-1. Control circuitry 14 may control voltages applied to anchor structures 124-1 and 124-2 to control a current through SMA wire 122-1. The current through SMA wire 122-1 may be adjusted to selectively contract SMA wire 122-1. When a current is applied to SMA wire 122-1 to cause the SMA wire to contract, the contraction may apply a force to flexure 126-1 in the positive X-direction. Flexure 126-1 (sometimes referred to as force redirecting structure 126-1 or lever 126-1) is attached to outer gear 114 and anchor structure 124-1. Flexure 126-1 may act as a lever that redirects the force from SMA wire 122-1. When a force is applied to anchor structure 124-1 in the positive X-direction by SMA wire 122-1, flexure 126-1 applies a force in direction 120-1 (in the negative Y-direction) to outer gear 114.

SMA actuator 116-2 in FIG. 10A includes an SMA wire 122-2 that is connected between anchor structures 124-3 and 124-4. Anchor structures 124-3 and 124-4 (sometimes referred to as connector structures 124-3 and 124-4, mechanical connection structures 124-3 and 124-4, electrical connection structures 124-3 and 124-4, mechanical and electrical connection structures 124-3 and 124-4, etc.) may be both mechanically and electrically connected to SMA wire 122-2. Mechanically, anchor structure 124-4 may be attached to a fixed structure in tunable lens 72-2 such as lens housing 102 whereas anchor structure 124-3 may be attached to flexure 126-2. Anchor structures 124-3 and 124-4 may also provide electrical connections to SMA wire 122-2. Control circuitry 14 may control voltages applied to anchor structures 124-3 and 124-4 to control a current through SMA wire 122-2. The current through SMA wire 122-2 may be adjusted to selectively contract SMA wire 122-2. When a current is applied to SMA wire 122-2 to cause the SMA wire to contract, the contraction may apply a force to flexure 126-2 in the negative X-direction. Flexure 126-2 (sometimes referred to as force redirecting structure 126-2 or lever 126-2) is attached to outer gear 114 and anchor structure 124-3. Flexure 126-2 may act as a lever that redirects the force from SMA wire 122-2. When a force is applied to anchor structure 124-3 in the negative X-direction by SMA wire 122-2, flexure 126-2 applies a force in direction 120-2 (in the positive Y-direction) to outer gear 114.

In the example of FIGS. 10A and 10B, SMA actuators 116-1 and 116-2 are attached to an upper surface of outer gear 114 whereas SMA actuators 116-3 and 116-4 are attached to a lower surface of outer gear 114. FIG. 10A is a top view of actuator 90 showing SMA actuators 116-1 and 116-2 whereas FIG. 10B is a rear view of actuator 90 showing SMA actuators 116-3 and 116-4.

SMA actuator 116-3 in FIG. 10B includes an SMA wire 122-3 that is connected between anchor structures 124-5 and 124-6. Anchor structures 124-5 and 124-6 (sometimes referred to as connector structures 124-5 and 124-6, mechanical connection structures 124-5 and 124-6, electrical connection structures 124-5 and 124-6, mechanical and electrical connection structures 124-5 and 124-6, etc.) may be both mechanically and electrically connected to SMA wire 122-3. Mechanically, anchor structure 124-6 may be attached to a fixed structure in tunable lens 72-2 such as lens housing 102 whereas anchor structure 124-5 may be attached to outer gear 114. Anchor structures 124-5 and 124-6 may also provide electrical connections to SMA wire 122-3. Control circuitry 14 may control voltages applied to anchor structures 124-5 and 124-6 to control a current through SMA wire 122-3. The current through SMA wire 122-3 may be adjusted to selectively contract SMA wire 122-3. When a current is applied to SMA wire 122-3 to cause the SMA wire to contract, the contraction may apply a force to anchor structure 124-5 (and therefore outer gear 114) in direction 120-3 (e.g., in the negative X-direction).

SMA actuator 116-4 in FIG. 10B includes an SMA wire 122-4 that is connected between anchor structures 124-7 and 124-8. Anchor structures 124-7 and 124-8 (sometimes referred to as connector structures 124-7 and 124-8, mechanical connection structures 124-7 and 124-8, electrical connection structures 124-7 and 124-8, mechanical and electrical connection structures 124-7 and 124-8, etc.) may be both mechanically and electrically connected to SMA wire 122-4. Mechanically, anchor structure 124-8 may be attached to a fixed structure in tunable lens 72-2 such as lens housing 102 whereas anchor structure 124-7 may be attached to outer gear 114. Anchor structures 124-7 and 124-8 may also provide electrical connections to SMA wire 122-4. Control circuitry 14 may control voltages applied to anchor structures 124-7 and 124-8 to control a current through SMA wire 122-4. The current through SMA wire 122-4 may be adjusted to selectively contract SMA wire 122-4. When a current is applied to SMA wire 122-4 to cause the SMA wire to contract, the contraction may apply a force to anchor structure 124-7 (and therefore outer gear 114) in direction 120-4 (e.g., in the positive X-direction).

In the actuator of FIGS. 10A and 10B, each SMA wire extends parallel to the length of chassis 102 (which extends in a ring around the tunable lens). This is in contrast to the actuator of FIG. 9, where two SMA wires extend parallel to the length of ring-shaped chassis 102 but two SMA wires extend orthogonal to the length of ring-shaped chassis 102. When SMA wires extend orthogonal to the length of ring-shaped housing 102 as in FIG. 9, the width 106 of the actuator and the lens housing is undesirably increased. When all of the SMA wires extend parallel to the length of ring-shaped housing 102 as in FIGS. 10A and 10B, the total width 106 of actuator 90 may be reduced (e.g., relative to FIG. 9). As an example, the width 106 in FIG. 10A may be less than 3 millimeters, less than 2.5 millimeters, etc.

The example in FIGS. 10A and 10B of having two SMA actuators with flexures attached to the upper surface of gear 114 and two SMA actuators without flexures attached to the lower surface of gear 114 is merely illustrative. In general, the SMA actuators with and without flexures may be attached to any desired portion of outer gear 114.

Additionally, the example in FIGS. 10A and 10B of having the bulk of the footprints of flexures 126-1 and 126-2 not overlap outer gear 114 is merely illustrative. In an alternative arrangement, flexures 126-1 and 126-2 may be formed on opposing upper and lower sides of outer gear 114. The footprint of flexure 126-1 may be entirely contained within the footprint of an upper surface of outer gear 114 and the footprint of flexure 126-2 may be entirely contained within the footprint of a lower surface of outer gear 114. This arrangement has the advantage of mitigating the overall footprint of actuator 90. However, care must be taken to ensure that flexure 126-1 does not interfere with screw 164 (e.g., the footprint of 126-1 is selected to not overlap screw 164).

As shown in FIG. 10A, each flexure may have a first portion 128-1 that extends along an edge of outer gear 114, a second portion 128-2 that is at an angle relative to portion 128-1, a third portion 128-3 that is at an angle relative to portion 128-2, a fourth portion 128-4 that is at an angle relative to portion 128-3, and a fifth portion 128-5 that is at an angle relative to portion 128-4. This example is merely illustrative and the flexure may have other desired shapes if desired.

Each SMA wire described herein may be formed from any desired SMA material (e.g., a material that returns to a pre-deformed or ‘remembered’ shape when heated). The flexures described herein may be formed from a metal material such as steel or another desired material.

The example herein of an actuator with multiple SMA actuators being used to adjust a tab of a lens shaper (and therefore adjust the curvature of the lens element attached to that lens shaper) is merely illustrative. In general, actuators of the type shown and described herein may be used to manipulate the curvature of a lens element, the position of a lens element, the position of a display, the position of a camera, and/or the position/properties of any other desired component in device 10.

The foregoing is merely illustrative and various modifications can be made to the described embodiments. The foregoing embodiments may be implemented individually or in any combination.

What is claimed is:

1. A tunable lens comprising:
a lens element having a periphery;
a ring-shaped chassis with a length that extends around the periphery; and
an actuator in the ring-shaped chassis configured to adjust a position of the lens element, wherein the actuator comprises:
a screw;
a nut that is aligned with the screw and that is attached to the lens element;
an inner gear that is connected to the screw;
an outer gear that surrounds the inner gear; and
four shape memory alloy (SMA) actuators that are configured rotate the inner gear by moving the outer gear, wherein each one of the four SMA actuators has a respective SMA wire that extends parallel to the length of the ring-shaped chassis.

2. The tunable lens defined in claim 1, wherein a first SMA actuator of the four SMA actuators comprises a first flexure and a first respective SMA wire, wherein the first flexure is connected to the outer gear, wherein the first SMA wire is configured to apply a first force to the first flexure in a first direction, and wherein the first flexure is configured to apply a second force to the outer gear in a second direction that is orthogonal to the first direction when receiving the first force from the first SMA wire.

3. The tunable lens defined in claim 2, wherein a second SMA actuator of the four SMA actuators comprises a second flexure and a second respective SMA wire, wherein the second flexure is connected to the outer gear, wherein the second SMA wire is configured to apply a third force to the second flexure in a third direction, and wherein the second flexure is configured to apply a fourth force to the outer gear in a fourth direction that is orthogonal to the third direction when receiving the third force from the second SMA wire.

4. The tunable lens defined in claim 3, wherein a third SMA actuator of the four SMA actuators comprises a third respective SMA wire, wherein the third SMA wire is configured to apply a fifth force to the outer gear in the first direction, wherein a fourth SMA actuator of the four SMA actuators comprises a fourth respective SMA wire, and wherein the fourth SMA wire is configured to apply a sixth force to the outer gear in the third direction.

5. The tunable lens defined in claim 4, wherein the first direction is opposite the third direction and wherein the second direction is opposite the fourth direction.

6. The tunable lens defined in claim 1, wherein the inner gear and the outer gear have a different number of teeth.

7. The tunable lens defined in claim 6, wherein the outer gear has at least one more tooth than the inner gear.

8. The tunable lens defined in claim 6, wherein the outer gear has at least two more teeth than the inner gear.

9. The tunable lens defined in claim 6, wherein the four SMA actuators are configured to move the outer gear in a circular path.

10. The tunable lens defined in claim 6, wherein the four SMA actuators are configured to move the outer gear in a circular path without rotating the outer gear.

11. The tunable lens defined in claim 1, wherein the outer gear has an upper surface and an opposing lower surface, wherein at least one of the four SMA actuators is attached to the upper surface, and wherein at least one of the four SMA actuators is attached to the lower surface.

12. The tunable lens defined in claim 1, wherein the actuator further comprises a guide rod and wherein the nut has a portion aligned with the guide rod.

13. A tunable lens comprising:
a lens element having a periphery;
a ring-shaped chassis that extends around the periphery; and
an actuator in the ring-shaped chassis configured to adjust a position of the lens element, wherein the actuator comprises:
a screw;
a nut that is aligned with the screw and that is attached to the lens element;
an inner gear that is connected to the screw;
an outer gear that surrounds the inner gear, wherein the inner gear and the outer gear have a different number of teeth; and
positioning equipment that is configured to rotate the inner gear by moving the outer gear in a circular path without rotating the outer gear.

14. The tunable lens defined in claim 13, wherein the positioning equipment comprises at least one piezoelectric actuator.

15. The tunable lens defined in claim 13, wherein the positioning equipment comprises at least one electrostatic actuator.

16. The tunable lens defined in claim 13, wherein the positioning equipment comprises at least one shape memory alloy (SMA) actuator.

17. The tunable lens defined in claim 13, wherein the actuator further comprises a guide rod and wherein the nut has a portion aligned with the guide rod.

18. The tunable lens defined in claim 13, further comprising:
a lens shaping element that is attached to the lens element, wherein the lens shaping element has a tab that extends into a recess in the nut.

19. An actuator comprising:
a screw;
a nut that is aligned with the screw, wherein rotation of the screw causes displacement of the nut along the screw;
an inner gear that is connected to the screw, wherein rotation of the inner gear causes rotation of the screw;
an outer gear that surrounds the inner gear, wherein the inner gear and the outer gear have a different number of teeth;
a first shape memory alloy (SMA) actuator comprising a first SMA wire;
a second SMA actuator comprising a second SMA wire;
a third SMA actuator comprising a third SMA wire; and
a fourth SMA actuator comprising a fourth SMA wire, wherein the first, second, third, and fourth SMA wires are parallel, and wherein the first, second, third, and fourth SMA actuators are configured to rotate the inner gear by moving the outer gear in a circular path.

20. The actuator defined in claim 19, wherein the outer gear is moved in the circular path a given number of times to cause one complete rotation of the inner gear and wherein the given number of times is equal to a number of teeth on the inner gear divided by a difference between the number of teeth on the inner gear and a number of teeth on the outer gear.
